(19) United States
(12) Patent Application Publication
(10) Pub. No.: US 2008/0320384 A1
(43) Pub. Date: Dec. 25, 2008

(54) AUTOMATED ADDITION OF IMAGES TO TEXT

(76) Inventor: Ramesh Nagarajan, Pittsford, NY (US)

Correspondence Address: Gibb & Rahman, LLC, 2568-A Riva Road Suite 304, Annapolis, MD, 21401, US

(21) Appl. No.: 11/767,564

(22) Filed: Jun. 25, 2007

(51) Int. Cl. G06F 17/30; G06F 15/00; G06F 17/00

(52) U.S. Cl. 715/255; 707/3; 707/E17.014

(57) ABSTRACT

After an electronic document that comprises text is input or received, a method embodiment automatically divides the electronic document into sections, such as paragraphs, chapters, pages, etc. The method automatically identifies a “theme” for each of the sections based on an automated analysis of words within the sections. Once the themes and sections are established, the method automatically searches a database of images for images which have identifiers that match the themes of the sections. By automatically matching the themes of the sections to the subject identifiers of the images, the method provides an image that matches a corresponding section of the document. Then, the method automatically adds a corresponding matching image to each of the sections to create a revised electronic document and outputs the revised electronic document.

### BACKGROUND AND SUMMARY

Embodiments herein generally relate to systems, methods, services, etc. for automatically adding images to previously created text documents.

Online book publishing is one of the largest growing industries. A company such as Lulu (www.lulu.com) is a marketplace for creators of content whereby creators and owners of digital content have complete control over how they use their work. Individuals, companies and groups can use Lulu to publish and sell a variety of digital content. This is enabling both on-demand printing and reading books online. Studies have always shown that pictures go a long way in communicating to the audience. For amateur writers and young authors (kids) penning down their thoughts is usually not difficult, but to create appropriate graphics or insert pictures is not a trivial task.

With one method embodiment herein, an electronic document that comprises text is input or received. The method automatically divides the electronic document into sections, such as paragraphs, chapters, pages, etc. The method automatically identifies a “theme” for each of the sections based on an automated analysis of words within the sections. A “theme” comprises a summary of items discussed within the section. In one alternative, the entire document can be examined for different themes and the “sections” can be made to cover a single theme.

Once the themes and sections are established, the method automatically searches a database of images for images which have identifiers that match the themes of the sections. In other words, this portion of the method identifies at least one “matching image” for each of the sections. The identifiers of the images each comprise a subject-based identification of items either contained within, or depicted by each of the images. Thus, by automatically matching the themes of the sections to the subject identifiers of the images, the method automatically provides an image that matches that section of the document. Then, the method automatically adds a corresponding matching image to each of the sections to create a revised electronic document and outputs the revised electronic document.

In a different, but similar, embodiment, the method performs the above automated image addition process of automatically identifying at least one theme for each of the paragraphs based on an automated analysis of words within each of the paragraphs, automatically searching a database of images for images having identifiers that match themes of the paragraphs to identify at least one matching image for each of the paragraphs, and automatically adding matching images adjacent corresponding ones of the paragraphs. Then this embodiment provides the user an option to individually accept or reject the matching images added to the electronic document. Thus, this method continually repeats the automated image addition process to replace images rejected by the user with different images, until this process is stopped by the user. Again, the electronic document having the matching images comprises a revised electronic document, which is output to the user.

With these embodiments, only one command to perform the automatic addition of the images is received from the user. After this single command, the automatic dividing, the automatic identifying, the automatic searching, and the automatic adding are performed after the command is received without further input from the user.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating an embodiment herein;

FIG. 2 is a schematic representation of a system according to an embodiment herein;

FIG. 3 is a schematic representation of a document processed according to an embodiment herein; and

FIG. 4 is a schematic representation of a document processed according to an embodiment herein.

### DETAILED DESCRIPTION

As mentioned above, the addition of images (pictures, illustrations, graphics, etc.) to previously created text documents is a laborious and time-consuming process. In addition, many users lack the creativity necessary to properly associate an image with the corresponding text. Thus, the embodiments herein provide processes, systems, services, computer programs, etc. to automatically add images to a text document.

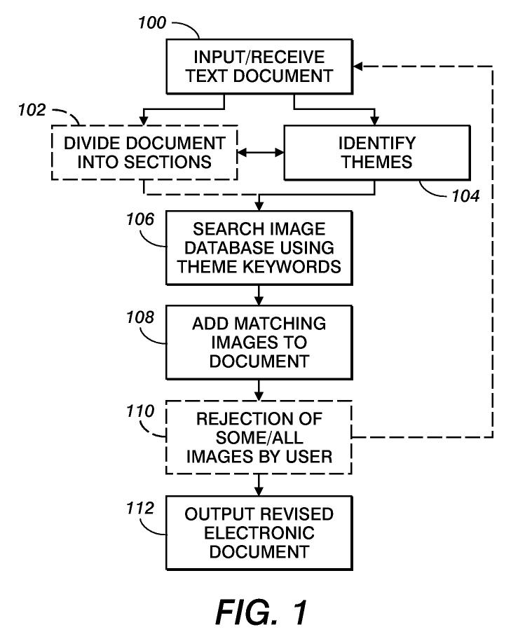

As shown in flowchart form in FIG. 1, with one method embodiment herein, an electronic document that comprises text is input or received in item 100. The document does not need to be exclusively text, but should contain sufficient textural portions to allow images/graphics to be added thereto. Further, the “document” supplied by the user could comprises a single sentence, a single paragraph, a single page, etc., or could comprise a multi-page, multi-paragraph writing. One example of such a document is a paper or book that has multiple chapters or paragraphs and that may or may not already include some pictures, graphs, illustrations, etc.

The method optionally automatically divides the electronic document into sections, such as paragraphs, chapters, pages, etc. in item 102 with the idea of adding an image (or more than one image) to each section. Alternatively, the document may not be divided into sections, and one or more images can be found for the document as a whole. This division operation can be set according to user preferences, programming defaults, or can be established according to the nature of the document, depending on the types of documents that are being processed. For example, the user can be provided the option through a graphic user interface to have an image appear on every page, at specific page intervals, at the beginning of each chapter, etc. Alternatively, the program can default to any of these options.

Further, in item 102, the embodiments herein can perform an analysis of the document and automatically establish division points. For example, the embodiments herein can divide the document into predetermined fractions (e.g., thirds, fourths, fifths, etc.) according to the number of pages. Similarly, the embodiments herein can count the number of paragraphs and divide the document into thirds, fourths, fifths, etc. according to paragraph count. Alternatively, a random number generator can randomly divide the document according to pages, paragraphs, etc. Similarly, the user can indicate (through pre-established user preferences) how and where the document should be divided into sections, and/or the use can highlight or select individual portions of text for which a them should be identified and for which an image should be added.

In item 104, the method automatically identifies a “theme” for each of the sections based on an automated analysis of words within the sections. A “theme” comprises a summary of items discussed within the section and can be based on a number of different criteria, such as the most common words, the location of words within the text, the nature of the usage of the words, etc. For example, one simple theme could comprise a phrase of the three most common words within a section (once pronouns, articles, conjunctions, etc. and other similar parts of speech are removed).

Thus, the method analyzes the content of the document and identifies all “relevant” keywords in the document. The methodologies for identifying themes and keywords within text is well-known and is described in, for example, U.S. Pat. Nos. 5,848,191 and 5,384,703 (incorporated herein by reference) and an exhaustive explanation of such techniques is omitted herefrom to maintain focus on the salient features of embodiments herein.

In one alternative, the entire document can be examined for different themes and the “sections” can be made to each cover a single or different theme. Therefore, in this alternative embodiment, the themes are identified in item 104 before the document is divided into sections in item 102. Thus, in this embodiment, item 102 would divide the document into a new section at a point where the theme transitioned from one theme to another different theme. In other words, different adjacent sections would have different themes.

The transitions from one theme to a different theme within the document can be automatically identified using a number of different automated processes. For example, the entire document can be evaluated to find an overall theme comprising a phrase of keywords, and each transition from one theme to a different theme can occur at the approximate initial occurrence of, or first heavy use of (e.g., first, fifth, tenth, etc. occurrence) each of the overall theme keywords. Thus, if the overall theme of a document or book were found to be “baseball, football, basketball, soccer, swimming, tennis” the approximate initial occurrence of (or initial heavy use of) any of these keywords (e.g., the fifth use of “basketball”) could signal the beginning of a different section within the document.

Similarly, the method can identify a transition to a different theme based on the density of any of the overall theme keywords (e.g., where density is the number of uses of an overall keyword per word count). Using the foregoing example, when the density of the overall theme keywords changes from “swimming” being the most densely used keyword to “football” being the most densely used word, a theme transition can be identified.

Alternatively, each page or paragraph can be individually analyzed for its own theme and a theme transition can be identified when a sufficient number (based on numbers or percentages) of the keywords change. Other similar methods of identifying transitions from one theme to another theme are intended to be included within the embodiments herein, and the foregoing are only examples used to illustrate the concept.

Once the themes and sections are established, the method automatically searches a database of images for images which have identifiers that match the themes of the sections, as shown in item 106. Thus, in this step, the method compares one or more of the keywords of the theme for a section with the identifiers of the image/graphics within the database and identifies at least one “matching image” for each of the sections.

The embodiments herein can use a previously established database (gallery) of images, illustrations, and graphics and associated keywords or the method can establish its own such database. The “identifiers” of the images comprise a subject-based identification of items either contained within, or depicted by each of the images. Thus, the “identifiers” of the images within the database can comprise names of the images, textural summaries of the images, etc.

By automatically matching the themes of the sections to the subject identifiers of the images in item 108, the method identifies at least one image that matches that section of the document. The theme can potentially have multiple keywords, and similarly the image identifiers can be made of multiple words. If at least one of the words in the image identifier matches one or more of the keywords for a given section, this match can be considered to produce a matching image for the section of the document.

If more than one image within the database matches the keyword(s) of the theme for that section, any number of different methods can be used to automatically select the one or more “matching images” for a given section. In one example, for quick processing, the first image or images that match the theme can be selected. Alternatively, the “most closely” matching image can be selected, where the most closely matching image can have an identifier that matches more of the keywords in the theme, when compared to the identifiers other “less closely” matching images in the database that match fewer of the keywords in the theme.

Other criteria for automatically selecting among multiple matching images can also be established as program defaults or by the user through the graphic user interface (as user preferences). For example, a preference can be set for color images over monochrome (or vice versa), a preference can be set for photographs over hand drawn images (or vice versa), a preference can be set for images from a specific author, a preference can be set for images from a specific time period or genre, or images with a certain minimum or maximum resolution or size, etc. These preferences can be satisfied based on the metadata associated with images within common databases, which list date, author, genre, resolution, size, as well as a wealth of additional information.

Thus, when a hit or match occurs, the selected images/graphics can be automatically added as illustrations within the corresponding sections of the document as shown in item 108. One example of processes that locate images for manual insertion based on manually identified words is shown in U.S. Patent Publication 2006/0080306, the complete disclosure of which is incorporated herein. The details of such processing are omitted herefrom, so as to focus on the features of embodiments herein.

Regarding the location of where the images will be inserted, the embodiments herein allow for many different options. For example, program defaults (or preset user preferences) can be set to have the image appear before the first paragraph in each section, at the top, middle, or bottom of pages, at the end of the sections, etc.

Alternatively, users could predefine areas in the book where appropriate space is left for the system to automatically identify the picture and appropriately re-size the image to fit in the allocated space. In such a case, each section could be established (in item 102) to begin or end where the user indicated that images should be positioned.

After the insertion of the images is done automatically on several pages in the book, the user can then preview the document and decide to retain or delete/modify them as needed, as shown in item 110. Thus, this embodiment provides the user an option to individually accept or reject the matching images automatically added to the electronic document. Further as shown by the arrow from item 110 to items 102 and 104 in FIG. 1, this method continually repeats (iterates) the automated image addition process to replace images rejected by the user with different images, until the user is satisfied and this iterative process is stopped by the user. As shown by item 112, the electronic document having the matching images comprises a revised electronic document, which is output to the user.

With these embodiments, only one command for the automatic addition of images from the user is needed to cause all the steps shown in FIG. 1 to be performed automatically. Thus, after this single command, the automatic dividing, the automatic identifying, the automatic searching, the automatic adding, the automatic outputting, etc., are performed without further input from the user. As mentioned above, many of the different types of processes that are preformed automatically can be selected according to program defaults or according to user preferences that are established before the user starts the automated process for any given document. This simplifies the process of creation of books on demand by eliminating the need to perform extensive manual searches for images.

Note that these embodiments are not limited to the specific user interface options described herein, and instead the specific user options are used herein merely as examples to illustrate one way in which the embodiments herein can operate. One ordinarily skilled in the art would understand that the user interface described herein can be modified substantially depending upon the specific application to which the embodiments herein find use.

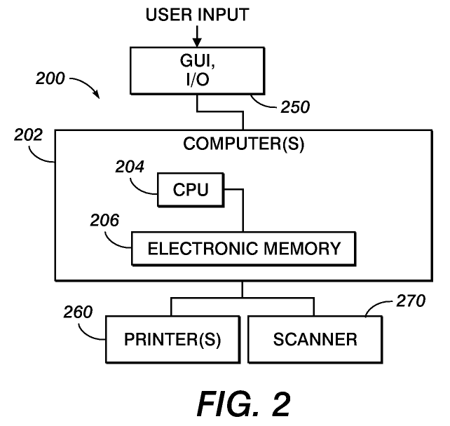

Another embodiment, shown in FIG. 2, comprises a system 200 that includes a central processing unit 204 (within a device, such as a printer or computer 202) and graphic user interface 250. The system 200 also includes a scanner 270 operatively connected to the graphic user interface 250 through the computer 202 and central processing unit 204. A memory 206 is provided in the system 200 operatively connected to the scanner 270 and the processor 204.

The graphic user interface 250 is adapted to receive input from the user, and such input could comprise the document, user preferences, and an identification of the image database to be used (which could be stored in the electronic memory 206 or which could be accessed through a network connected to the input/output 250). Further, the scanner 270 can be used to scan images and the printer 260 can be used to print the revised document (after the images have been automatically added). The processor 204 performs the steps shown in FIG. 1.

Various computerized devices are mentioned above. Computers that include input/output devices, memories, processors, etc. are readily available devices produced by manufactures such as International Business Machines Corporation, Armonk N.Y., USA and Apple Computer Co., Cupertino Calif., USA. Such computers commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Stamford, Conn., USA and Visioneer, Inc. Pleasanton, Calif., USA and the details of such devices are not discussed herein for purposes of brevity and reader focus.

The word “printer” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. Printers are readily available devices produced by manufactures such as Xerox Corporation, Stamford, Conn., USA. Such printers commonly include input/output, power supplies, processors, media movement devices, marking devices etc., the details of which are omitted herefrom to allow the reader to focus on the salient aspects of the embodiments described herein.

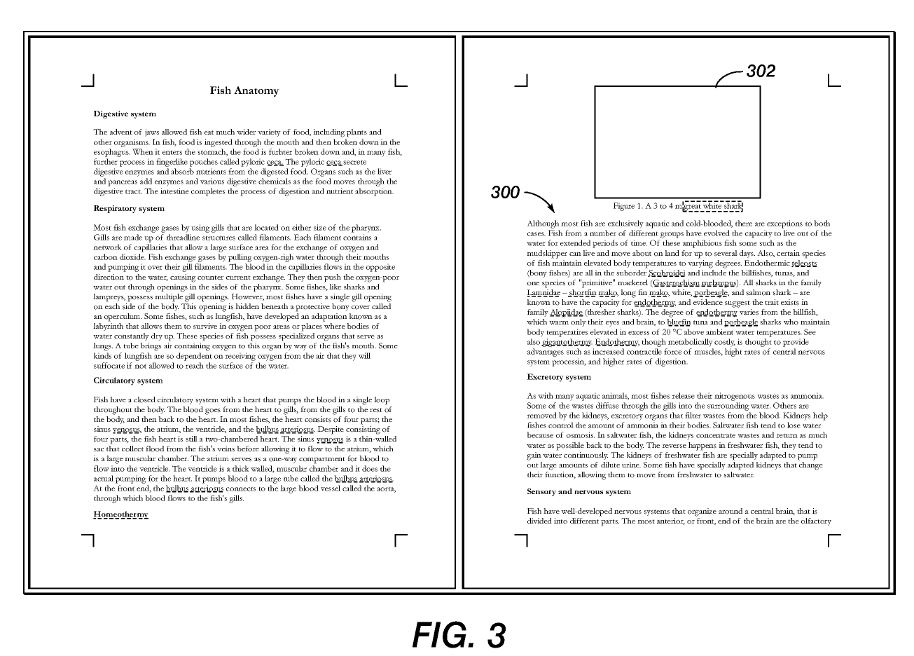

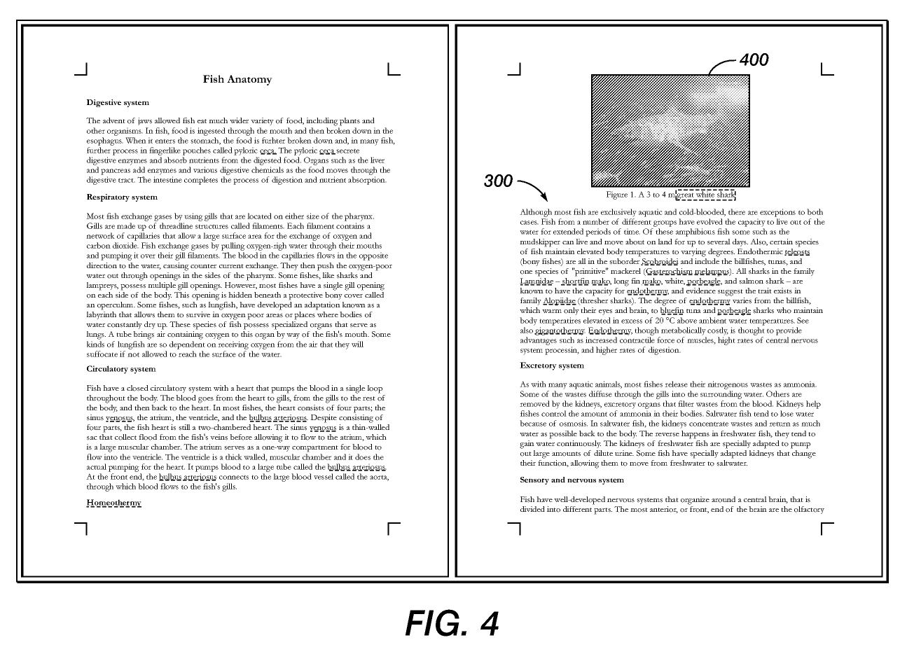

FIGS. 3 and 4 illustrate one non-limiting example of some of the embodiments herein applied to a document (such as an online book) having text 300. Note that in FIGS. 3 and 4 some words of the text 300 have been automatically highlighted by the automated theme identification step (104) and some of such highlighted words form the theme for the section of text. Item 302 illustrates an area where the image will be added (as determined automatically or manually, as discussed above). FIG. 4 illustrates the matching image 400 that has been automatically inserted in the area 302 (item 108).

All foregoing embodiments are specifically applicable to electrostatographic and/or xerographic machines and/or processes as well as to software programs stored on the electronic memory (computer usable data carrier) 206 and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
providing an electronic document comprising text;
automatically identifying at least one theme of at least one paragraph of said text based on an automated analysis of words within said paragraph;
automatically searching a database of images for at least one image having an identifier that matches said theme to identify at least one matching image;
automatically adding said matching image to said electronic document adjacent said paragraph to create a revised electronic document; and
outputting said revised electronic document.

2. The method according to claim 1, further comprising providing an option to accept or reject said adding of said matching image to said electronic document.

3. The method according to claim 1, wherein said theme comprises a summary of said paragraph.

4. The method according to claim 1, wherein said identifier of said image comprises a subject-based identification of items one of contained within and depicted by said image.

5. The method according to claim 1, further comprising receiving, from a user, a command,
wherein said automatically identifying, said automatically searching, and said automatically adding are performed after said command is received without further input from said user.

6. A method comprising:
providing an electronic document comprising text;
automatically dividing said electronic document into sections;
automatically identifying a theme for each of said sections based on an automated analysis of words within said sections;
automatically searching a database of images for images having identifiers that match themes of said sections to identify at least one matching image for each of said sections;
automatically adding a corresponding matching image to each of said sections to create a revised electronic document; and
outputting said revised electronic document.

7. The method according to claim 6, wherein said dividing of said electronic document divides said electronic document one of: at paragraphs; at chapters; at pages; and at changes in themes.

8. The method according to claim 6, wherein said theme comprises a summary of a corresponding section.

9. The method according to claim 6, wherein said identifiers of said images each comprise a subject-based identification of items one of contained within and depicted by each of said images.

10. The method according to claim 6, further comprising receiving, from a user, a command,
wherein said automatically dividing, said automatically identifying, said automatically searching, and said automatically adding are performed after said command is received without further input from said user.

11. A method comprising:
receiving an electronic document comprising at least one paragraph of text from a user;
performing an automated image addition process comprising:
automatically identifying at least one theme for said paragraph based on an automated analysis of words within said paragraph;
automatically searching a database of images for images having identifiers that match said theme of said paragraph to identify at least one matching image for said paragraph; and
automatically adding said matching image to said electronic document adjacent said paragraph;
providing said user an option to accept or reject said matching image added to said electronic document;
continually repeating said automated image addition process to replace images rejected by said user with different images, until stopped by said user, wherein said electronic document having matching images comprises a revised electronic document; and
outputting said revised electronic document.

12. The method according to claim 11, wherein said theme comprises a summary of said paragraph.

13. The method according to claim 11, wherein said identifiers of said images each comprises a subject-based identification of items one of contained within and depicted by each of said images.

14. The method according to claim 11, further comprising receiving, from a user, a command to perform said automated image addition process,
wherein said automatically identifying, said automatically searching, and said automatically adding are performed after said command is received without further input from said user.

15. A service comprising:
providing an electronic document comprising text;
automatically identifying at least one theme of at least one paragraph of said text based on an automated analysis of words within said paragraph;
automatically searching a database of images for at least one image having an identifier that matches said theme to identify at least one matching image;
automatically adding said matching image to said electronic document adjacent said paragraph to create a revised electronic document; and
outputting said revised electronic document.

16. The service according to claim 15, further comprising providing an option to accept or reject said adding of said matching image to said electronic document.

17. The service according to claim 15, wherein said theme comprises a summary of said paragraph.

18. The service according to claim 15, wherein said identifier of said image comprises a subject-based identification of items one of contained within and depicted by said image.

19. The service according to claim 15, further comprising receiving, from a user, a command,
wherein said automatically identifying, said automatically searching, and said automatically adding are performed after said command is received without further input from said user.

20. A computer program product comprising:
a computer-usable data carrier storing instructions that, when executed by a computer, cause said computer to perform a method comprising:
providing an electronic document comprising text;
automatically identifying at least one theme of at least one paragraph of said text based on an automated analysis of words within said paragraph;
automatically searching a database of images for at least one image having an identifier that matches said theme to identify at least one matching image;
automatically adding said matching image to said electronic document adjacent said paragraph to create a revised electronic document; and
outputting said revised electronic document.
